(19) United States
(12) Patent Application Publication
(10) Pub. No.: US 2009/0326989 A1
(43) Pub. Date: Dec. 31, 2009

(54) INTERACTIVE INFORMATION MANAGEMENT SYSTEM AND METHOD

(76) Inventors: Brett A. Schmitt, Shawnee, KS (US); Jamie E. Gladman, Leawood, KS (US)

Correspondence Address: LAW OFFICE OF MARK BROWN, LLC, 4700 BELLEVIEW SUITE 210, KANSAS CITY, MO, 64112, US

(21) Appl. No.: 12/555,557

(22) Filed: Sep. 8, 2009

Related U.S. Application Data
(63) Continuation-in-part of application No. 11/087,344, filed on Mar. 23, 2005.

(51) Int. Cl. G06Q 40/00

(52) U.S. Cl. 705/4

(57) ABSTRACT

A method is provided for interactively managing insurance claim information using a web site with an insured side and an insurer side. An insured provides information pertaining to lost or damaged items associated with a property loss claim. Upon submitting a claim to the claim management system, the insurer has access to the information from the insurer side of the website to process the claim. The adjuster can verify the information associated with each item, and can adjust the estimated replacement values for each item before reimbursing the insured for the claim and memorialize a justification for the adjustment. The adjuster can assist an insured with submission of the claim by remotely accessing the insured's claim on the insured's side of the website and either completing the claim information on their behalf, or coach the insured during completion of the claim.

### CROSS-REFERENCE TO RELATED APPLICATION

This application is a continuation-in-part of and claims priority in U.S. patent application Ser. No. 11/087,344 filed Mar. 23, 2005 which is incorporated herein by reference.

### BACKGROUND OF THE INVENTION

1. Field of the Invention

The present invention relates generally to interactive information management, and in particular to a system and method for submitting, verifying and processing insurance property loss claims via a web site selectively accessible by insureds/claimants and insurers, including carriers and claims adjusters.

2. Description of the Related Art

Various commercial transactions involve submitting and managing information. Commercial transactions generally involve two or more participants, each of whom performs a particular role in concluding the transaction. For example, in the insurance field the participants include: insurers, which provide loss indemnification insurance services; claims adjusters who review submitted claims; insureds; and others. When covered losses occur, insureds/claimants commonly submit claims to adjusters for processing and compensation for their losses.

An insurance claim processing transaction generally includes the insured submitting information concerning the loss to the insurer, which may utilize the services of an independent claims adjuster. A large property loss claim can involve a significant amount of loss-related information, which must be collected, submitted, tabulated, verified and adjusted in order to conclude the adjustment process and settle the claim. For example, a claim involving damage to or the destruction of a structure and its contents tends to be a relatively time-consuming and labor-intensive claim to process. Such claims often arise under homeowners' policies, which provide coverage for dwellings and their contents. A major loss resulting from a catastrophe such as a fire, a burglary or a natural occurrence can involve a large number of lost or damaged property items. Identifying and valuing those items previously consumed large amounts of time on the part of the adjusters and the insureds/claimants. Automating such procedures and providing convenient, interactive, on-line systems for exchanging and managing claims-related information could expedite and otherwise improve the process for both the insurers and the insureds/claimants.

The prior art includes systems and methods for handling insurance claims with computer networks automating many of the information-processing procedures. For example, Chen et al. U.S. Pat. No. 5,504,674 disclose an insurance claims estimate, text and graphics network and method. Borghesi et al. U.S. Pat. No. 5,950,169 disclose a system and method for managing insurance claim processing. However, heretofore there has not been available a system and method for interactively managing information with the advantages and features of the present invention.

The present invention addresses some of the time-consuming and labor-intensive aspects of information management, such as the processing of property loss claims under insurance policies.

### SUMMARY OF THE INVENTION

In the practice of the present invention, a system is provided for interactively managing information using a web site with submitter and receiver sides. A submitter provides information in connection with a transaction, such as processing an insurance claim. The information can be grouped in predetermined categories. The information recipient, such as a claims adjuster in the case of an insurance claim, can access the information via the receiver side of the web site. The information can be processed, e.g. adjusted, in connection with concluding the transaction. The web site can link to various other resources, which can provide additional information for use in connection with concluding the transaction.

### BRIEF DESCRIPTION OF THE DRAWINGS

FIG. 1 is a schematic block diagram of the major participants in an insurance claim processing transaction according to the method of the present invention.

FIG. 2 is a flowchart of an initiation and set up phase of the method of the present invention.

FIG. 3 is a flowchart of the insured side of an inventory portion of the method of the present invention.

FIG. 4 is a flowchart of the insurer side of the inventory portion of the method of the present invention.

FIG. 5 shows a login screen on the insured side of the web site.

FIG. 6 shows a personal information screen on the insured side of the web site.

FIG. 7 shows a screen for editing personal information on the insured side of the web site.

FIG. 8 shows a screen for editing claim-related information from the insured side of the web site.

FIG. 9 shows portions of screens displaying a categorized lost property listing, which can be accessed from the insured and insurer sides of the web site.

FIG. 10 shows a screen on the insurer side of the web site for use in connection with adjusting a property loss claim.

FIG. 11 shows a screen on the insurer side of the web site for providing an adjuster with a list of insured clients with open claim files.

FIG. 12 is a flowchart of the insured side of an inventory portion of an alternative embodiment method of the present invention.

FIG. 13 is a flowchart of the insurer side of the inventory portion of an alternative embodiment method of the present invention.

FIG. 14 shows a screen on the insurer side of the web site for use in connection with adjusting a property loss claim of an alternative embodiment of the present invention.

FIG. 15 shows a screen for editing claim-related information from the insured side of the website of an alternative embodiment of the present invention.

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed system or method.

Referring to the drawings in more detail, the reference numeral 2 generally designates a claims management system (CMS) embodying the present invention. Without limitation on the generality of useful applications of the present invention, the disclosed embodiment comprises a system for managing information in connection with processing property loss insurance claims. Other types of systems and relationships among parties involving the exchange of information and commercial transactions based on same could utilize the system 2 of the present invention. For example, the system of the present invention can be utilized in connection with handling other types of insurance claims, such as life, health and disability. The system 2 includes a web site 4, which can be subdivided into different parts for access by respective participants in the system 2.

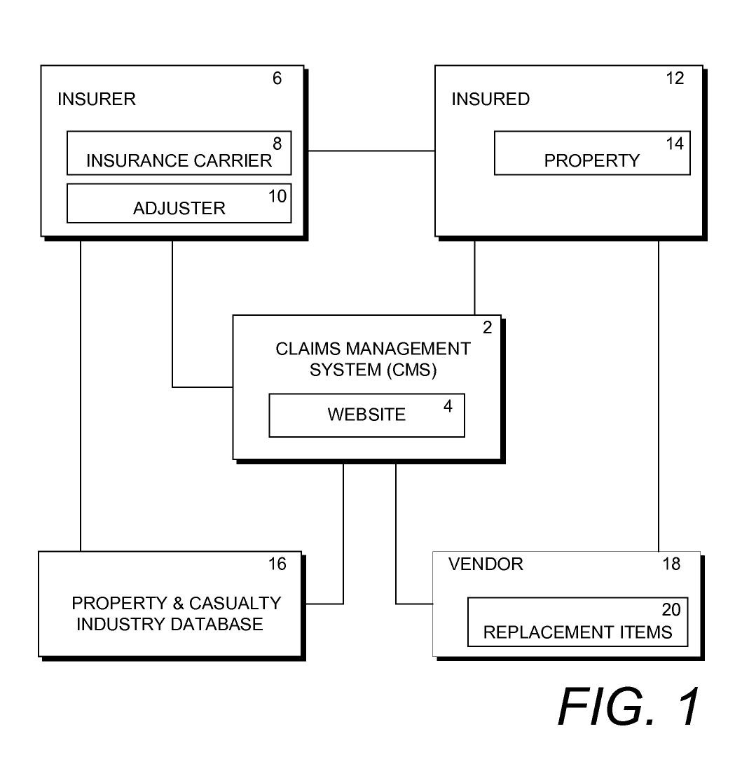

The major participants in the system 2 and their interrelationships are schematically depicted in FIG. 1. An insurer 6 includes an insurance company or carrier 8 and an adjuster 10. The carrier 8 and the adjuster 10 can be a single entity or separate entities. Within the insurance industry many carriers utilize the services of independent adjusters. The insurer 6 is linked to the claims management system 2 and the insurer side of the website 10, e.g. via the Internet worldwide network or otherwise. An insured 12 can possess property 14, which can be covered by an insurance policy provided by the insurer 6.

An optional property and casualty (P & C) industry database 16 can be linked to the CMS 2 for access by the insurers 6. The database 16 can receive, store, process and make available, under appropriate conditions, information relating to claims for use by insurers, who can subscribe to such services. Vendors 18 can link to both the CMS 2 and the insureds 12 for expediting the replacement of lost property with replacement items 20. For example, vendors 18 can compensate the administrator of the CMS 2 for being linked thereto and for the referrals of insureds with property losses, which referrals can generate sales of replacement items 20.

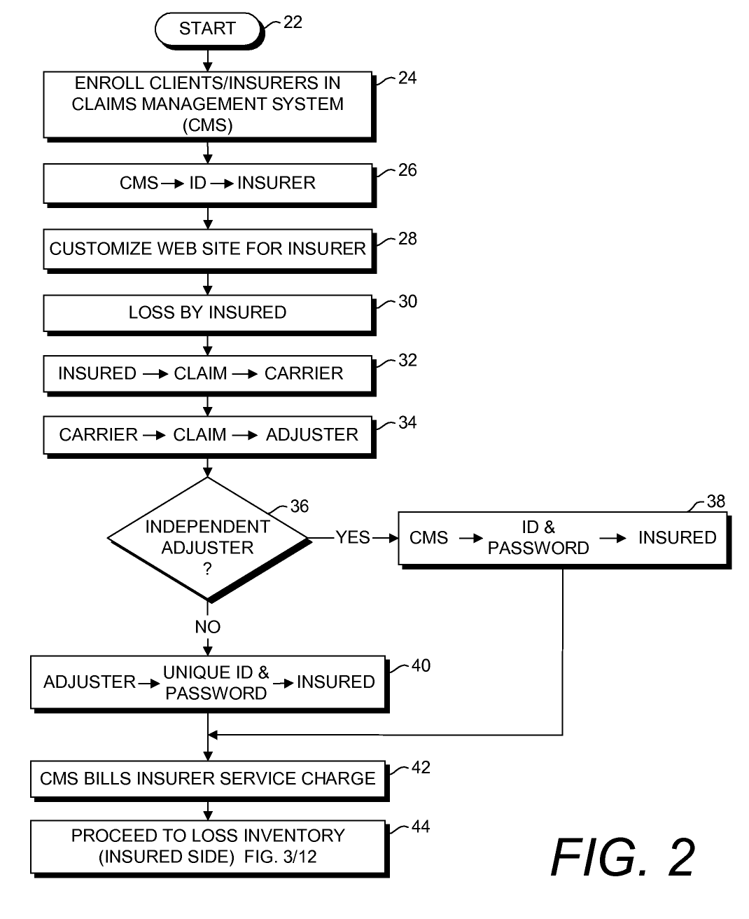

FIG. 2 shows the process for initializing the CMS 2 and a claim, for example but without limitation a property loss claim. From a start at 22, the process proceeds to an enroll clients/insurers step 24, whereat insurance carriers are solicited to participate in the CMS 2. Other types of clients could also enroll in and utilize the CMS 2, such as insurance adjusters who could promote the superior service aspects of the CMS 2 in conjunction with marketing their claims adjustment services. The clients/insurers 6 are provided with unique identification codes at step 26, which permit them to access an insurer side of the web site 4. The web site can be customized for the clients/insurers 6 at 28, for example by incorporating the logo and other identifying information for the insurance carriers 8, the adjusters 10 or other entities utilizing the CMS 2. The web site 4 can thus be customized to the specific requirements of the clients/insurers 6 and promote their respective products and services.

Step 30 represents a loss by an insured 12, which can result from various events, including major catastrophes such as fires, burglaries, natural occurrences, etc. The process then proceeds to step 32 whereat the insured/claimant 12 submits a claim to the insurer/carrier 6, which refers the claim to an adjuster 10 at step 34. The adjuster 10 can be an employee of the insurer 6, or an independent adjuster who adjusts claims for one or more insurance carriers. If an independent adjuster is utilized (affirmative decision at 36) the process proceeds to 38 whereat the CMS 2 provides the insured 12 with a unique identification and password. A negative determination at 36 can proceed to 40 whereat a company's adjuster provides the insured 12 with a unique identification and password. It will be appreciated that various procedures and security measures can be implemented in connection with the issuance of user names and passwords for claims processing purposes. The CMS 2 automatically bills the insurer 6 a service charge at 42, which can be based on ongoing periodic service fees, event-specific charges, licensing fees or other suitable compensation arrangements. The method proceeds to the loss inventory procedure at 44.

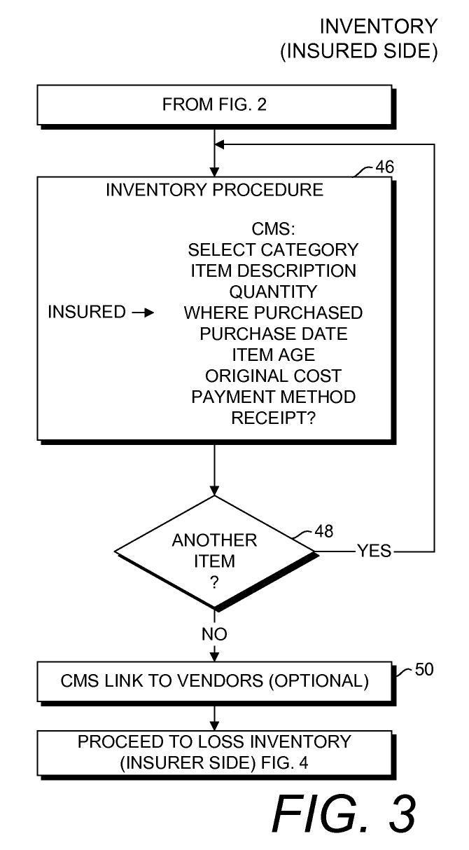

FIG. 3 shows the inventory loss procedure from the insured side of the web site 4. The inventory procedure is shown at 46. Without limitation on the various types of claim-related information that can be submitted by the insured 12 to the CMS 2, the claim-related information can include categories (e.g., dwelling contents categorized by room, etc.), item descriptions, quantities, purchase location, purchase date, item age, original cost, payment method and an indication of whether or not the insured 12 has the original purchase receipt. The inventory procedure 46 can optionally include a procedure for checking pricing, e.g. by linking to vendors 18 of replacement items 20. For example, a shopping cart type of replacement item pricing procedure can be utilized whereby replacement items are placed in a virtual shopping cart, which is “full” at the end of the inventory procedure. The inventory procedure 46 repeats if another item is to be submitted with the claim (affirmative branch from decision box 48). The negative branch from the decision box 48 leads to an optional CMS 2 link to vendors 18 at 50, whereby the insured 12 can be referred to appropriate vendors 18 of replacement items for those lost.

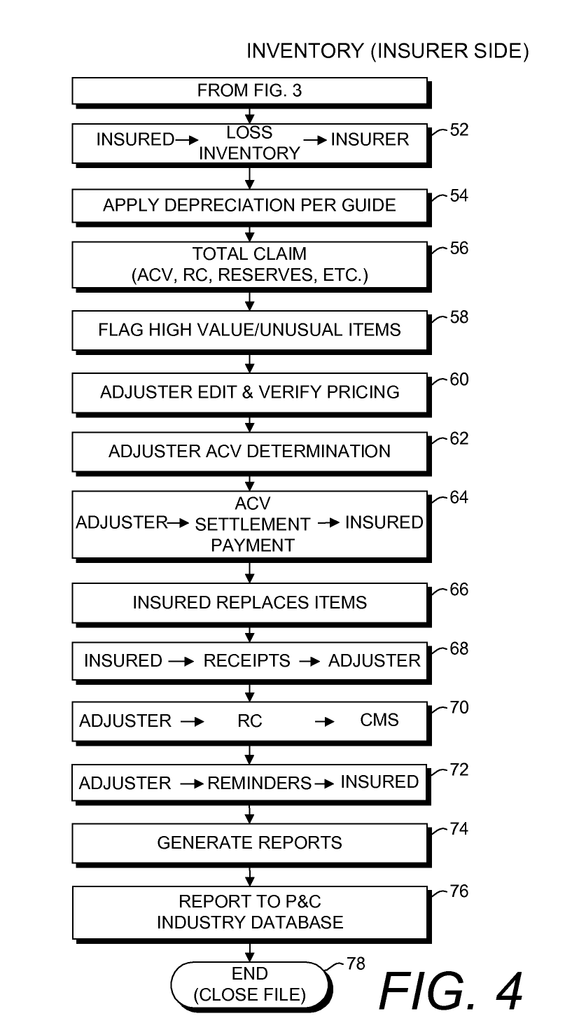

FIG. 4 shows the inventory loss procedure from the insurer side of the web site 4. The completed loss inventory is automatically submitted to the adjuster 10 on the insurer side of the web site 4 at 52. The CMS 2 can optionally automatically apply depreciation to the lost property inventory according to policy depreciation guidelines at 54. The total claim is tabulated at 56, based on, for example, actual cash value (ACV), replacement cost (RC), claims reserves, etc. Unusually high values for individual items can be flagged at 58. For example, all items with replacement costs exceeding a predetermined amount can be automatically flagged for verification. Moreover, categories of items can be examined for total purchases during predetermined time periods, such as all clothing purchases on a yearly basis. Total purchase amounts which are unusually high or exceed guidelines could automatically caused the category to be flagged for further inquiry, verification and possible adjustment. The CMS 2 can automatically apply predetermined guidelines based on reasonable expectations of purchases on a categorical and yearly basis. The CMS 2 can thus provide a control function in connection with adjusting insurance claims and preventing excessive claim settlements. The adjuster 10 edits the claim and verifies pricing at 60 and makes an actual cash value determination at 62. Based on the adjustment, payment can be provided to the insured at 64 and the lost items replaced at 66. Item replacement can be accomplished through an optional on-line electronic shopping function via links to vendors 18 of replacement items 20. According to the claims adjustment procedures followed by the insurer 6, receipts may be submitted to the adjuster at 68, who can provide an update of the replacement cost (RC) to the CMS 2 at 70. The CMS 2 can provide reminders to the insured 12 at 72, for example if requested information has not been received for a predetermined period of time, whereby the CMS 2 generates appropriate reminders. Reports of the claim settlement can be generated at 74 according to the procedures of the insurer 6, which can require such reports at predetermined intervals. Appropriate letters, reports, reminders and other types of information can optionally be automatically generated and submitted to the appropriate recipients by the CMS 2. For example, the insured 12 can receive periodic reminders advising him or her that the claim file is still open and identifying the number of items pending, paid, etc. Optionally, information pertaining to the claim can be submitted to the P & C industry database 16 at 76, whereafter the procedure proceeds to close the file at 78, ending the claim management process.

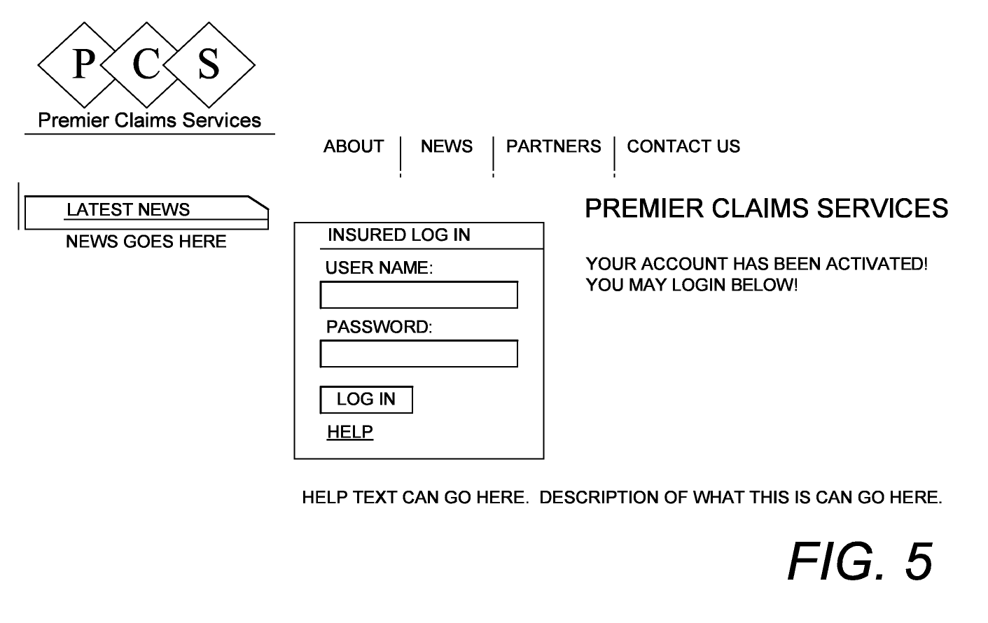

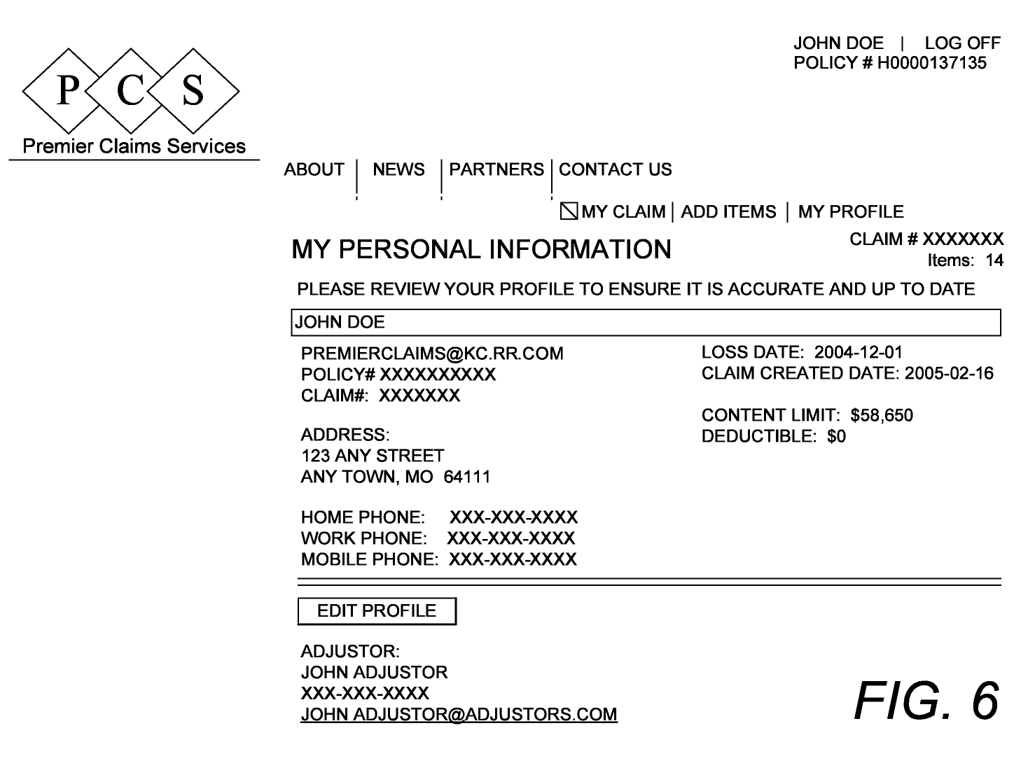

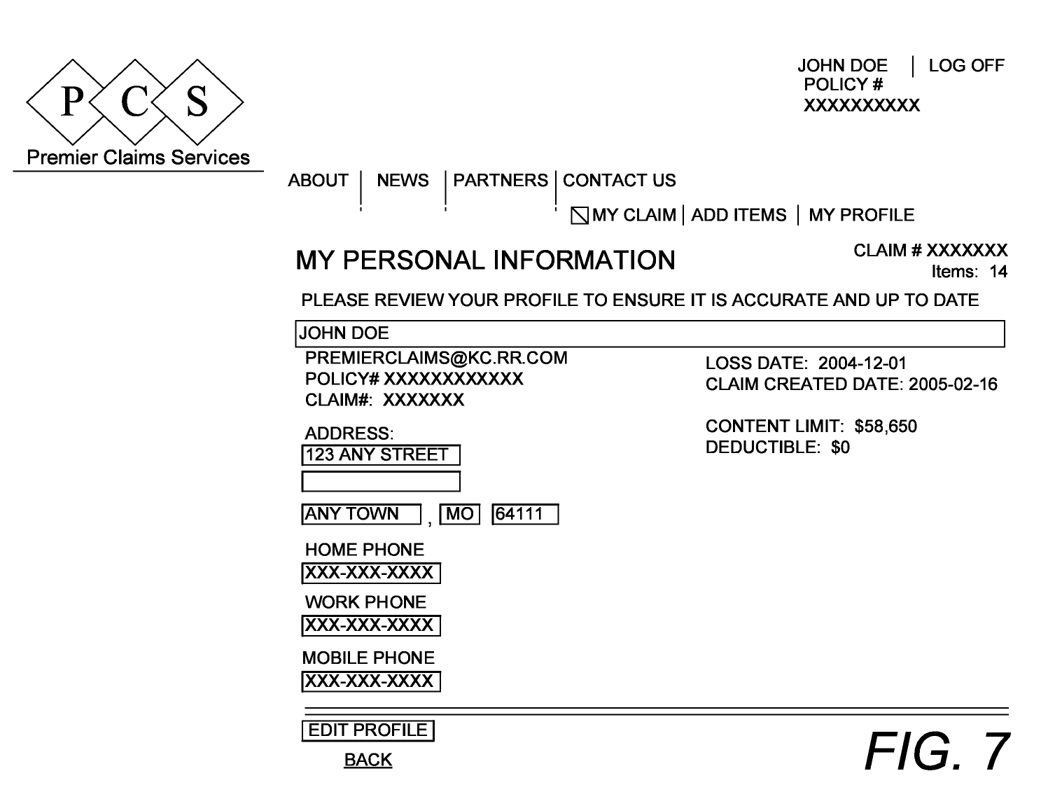

FIG. 5 shows a screen display from the insured side of the web site 4. Insured login information, including username and password, can be submitted to the CMS 2 via this screen. Other menu options can be provided for obtaining and submitting other types of information, as shown. Also, the screen display of FIG. 5, like the other screen displays accessible through the CMS web site 4, can be provided with text and graphics identifying one or more of the insurer 6, the insurance company 8 and/or the adjuster 10, including appropriate links, contact options, etc. FIG. 6 shows a display screen for the insured side, which displays a profile including his or her personal information. FIG. 7 shows a screen for editing the insured's profile, e.g. with updated personal information. Such information is typically obtained and recorded by the insurers 6, which could enter same on the insurer side of the web site 4. Alternatively, such personal profile information could be submitted and/or edited by the insureds 12.

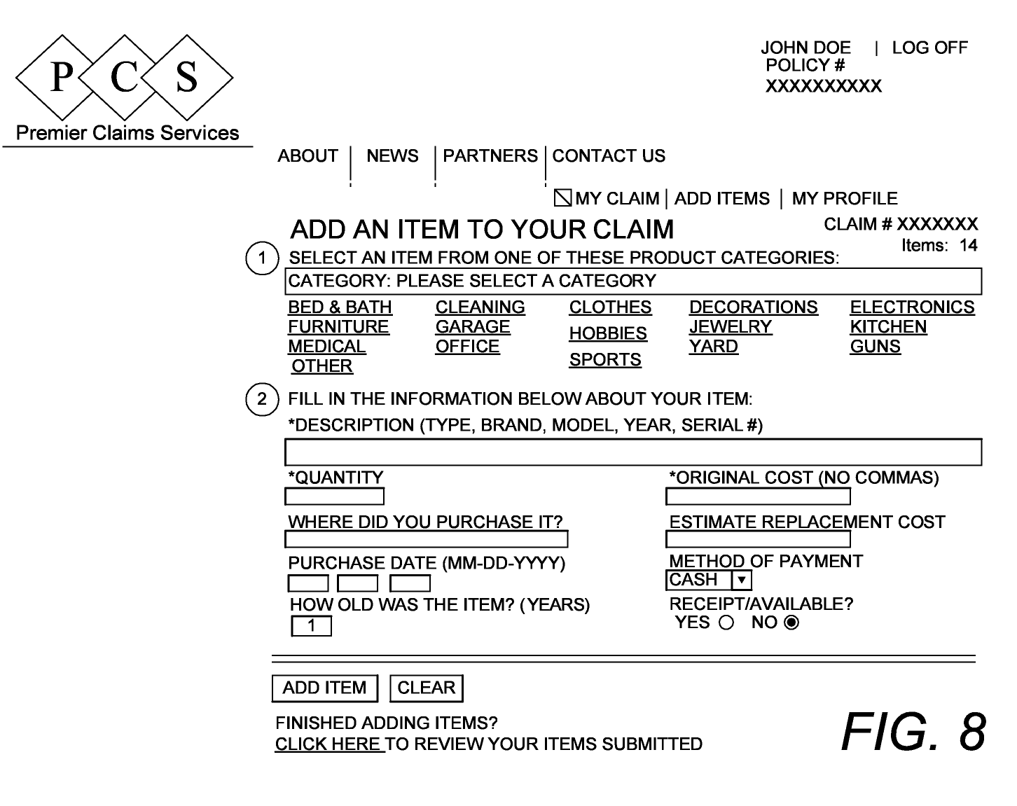

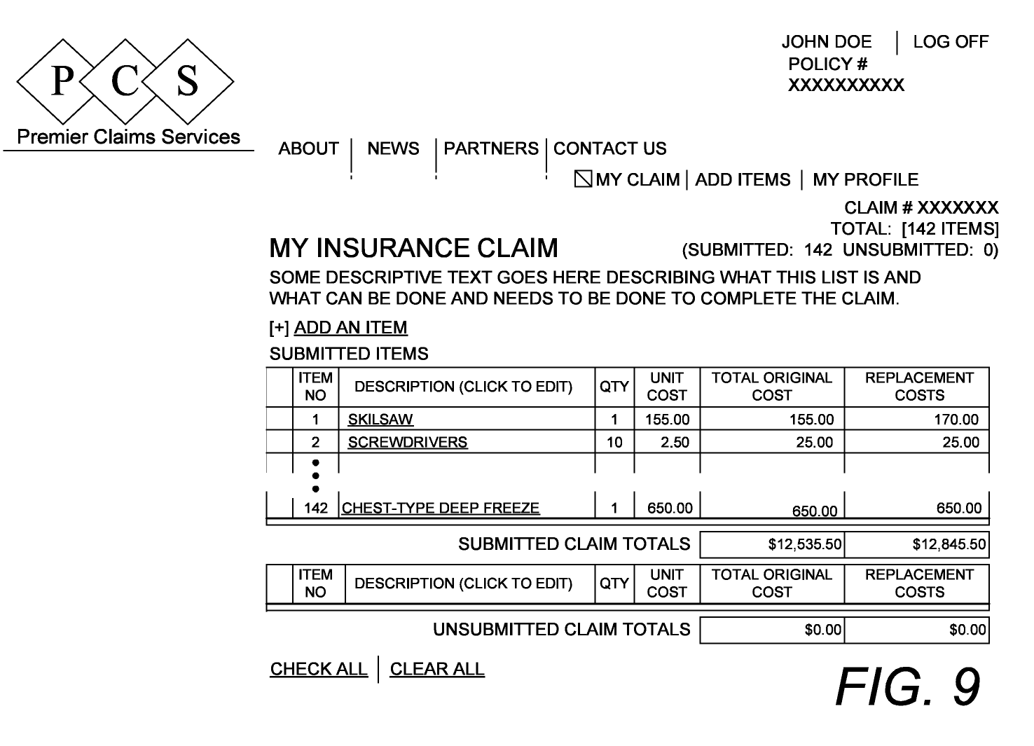

FIG. 8 shows a screen display for interactively adding a lost or damaged item of insured property to a claim from the insured side of the web site 4. The display shown therein is an example of a type of screen display that can be used for interactively submitting claim information for a personal property item under a homeowner's policy. Various other types of information could be submitted in various other formats within the scope of the present invention. A product category is first chosen from a list of categories of household items. Submitted items are thus categorized. Item-specific information is then submitted, including description, quantity, where purchased, when purchased, age when purchased, original cost, estimated replacement cost, payment method and an indication of the availability of a receipt. When the insured finishes submitting the categorized lists of damaged or lost items, a comprehensive insurance claim inventory report is generated, as shown in FIG. 9. Various information can be tabulated and displayed, including item number, description, quantity, unit cost, total original cost and replacement cost. The insurance claim inventory is submitted to the adjuster 10 for review, verification, adjustment and claim payment. The inventory thus also becomes accessible via the insurer's side of the web site 4. The inventory can assume various formats and information displays as required. The procedure for submitting lost property claims can interactively utilize the Internet worldwide network. Other interaction methodologies can also be utilized, such as telephonic, etc.

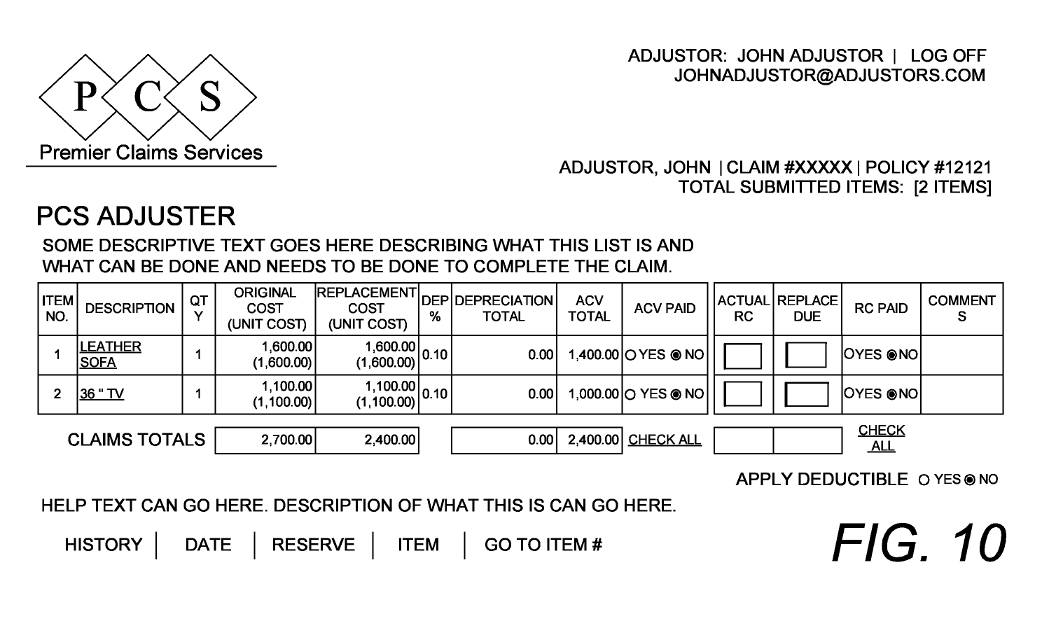

FIG. 10 shows a screen on the insurer side of the web site 4, which can be utilized by the adjuster 10 in connection with adjusting a property loss claim. Without limitation, the information entered can include: item number; description; quantity; original cost (unit cost); replacement cost (unit cost); depreciation percentage, depreciation total; ACV total; and ACV paid. All such information can be submitted and processed prior to the damaged or lost items being replaced. After replacement, additional information can be submitted, which can include: actual RC; replacement due; RC paid; and comments. The CMS 2 can provide control over the inventory and claim adjustment process whereby claim limits, reserves, depreciation schedules and guidelines are automatically imposed. However, the CMS 2 can enable the adjuster 10 to override such controls with manual entries and to provide comments in the comment column explaining such manual overrides. Thus, the insurer 6 can establish claim adjustment procedures with the ability to override same when necessary. The comments of the adjuster 10 can provide documentation and justification for such overrides. The CMS 2 thus provides security for its administrator, particularly in the event claims are settled for amounts in excess of the predetermined guidelines (e.g., in certain categories) of the insurer 6, because a record is made of the adjuster's comments justifying such manual overrides. The screen shown in FIG. 10 can provide the adjuster 10 with a number of other functions, such as retrieving claim-related information by history, date, reserve, item (e.g., go to item), etc.

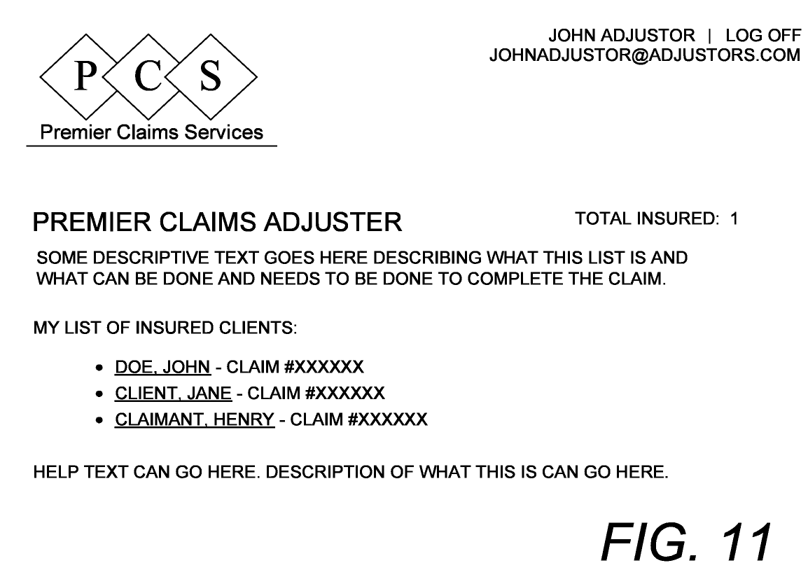

FIG. 11 shows a screen on the insurer side of the web site 4, which can provide the adjuster 10 with lists and status information pertaining to insureds that he or she is working with, and status information concerning their open claim files. The CMS 2 can provide an archive function via the screen shown in FIG. 11 whereby the insureds/claimants files can be archived, e.g., if they are inactive or closed.

### II. Alternative Embodiment CMS 2

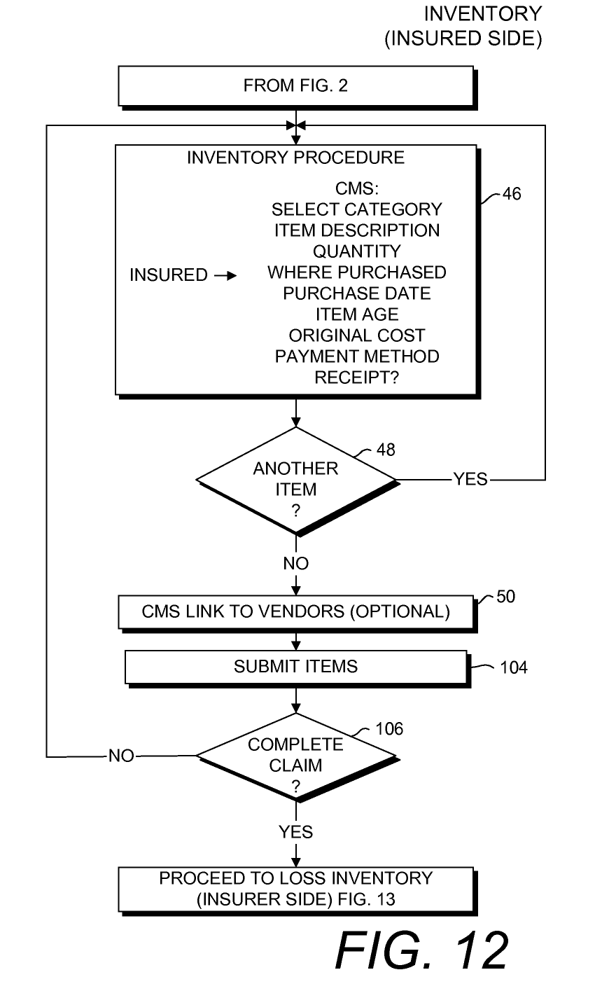

Referring to FIGS. 12-15, an alternative embodiment CMS 2 embodying principles of the present invention is shown and described. FIG. 12 shows the inventory loss procedure from the insured 12 side of the web site 4 as previously shown and described in FIG. 3 including the additional steps of submitting the items 104 and making an affirmative decision to complete the claim 106. The inventory procedure 46 is repeated as additional items are added to a claim as described above, however, the additional step of memorializing the items accumulated during the inventory procedure 46 in a submit item list step is shown at 104. Once the insured 12 is finished entering items, the insured 12 may complete the claim (affirmative branch from decision box 106) or may return to the inventory procedure 46 (negative branch from decision box 106). The insured 12 may continue with the inventory procedure 46 or may leave the CMS 2 to return at a later time, and as many times as needed, to enter all claim items in the inventory procedure 46 to complete the claim. The affirmative branch from decision box 106 notifies the adjuster 10 that the insured 12 has completed their loss inventory and makes the loss inventory available to the insurance carrier 8 and adjuster 10 on the insurer's 6 side of the website 4 carrying the insured's 12 claim data forward through the claims management process.

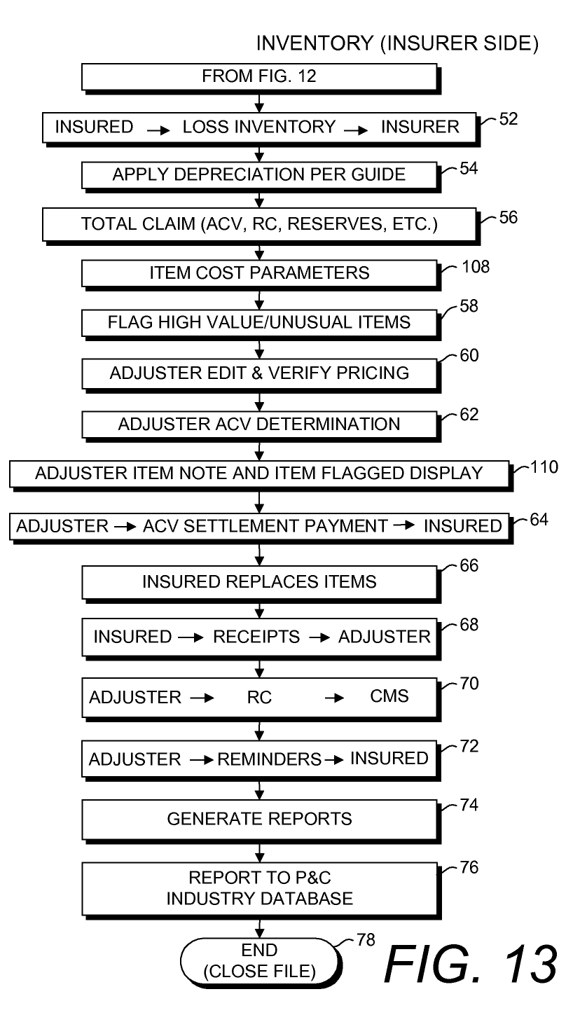

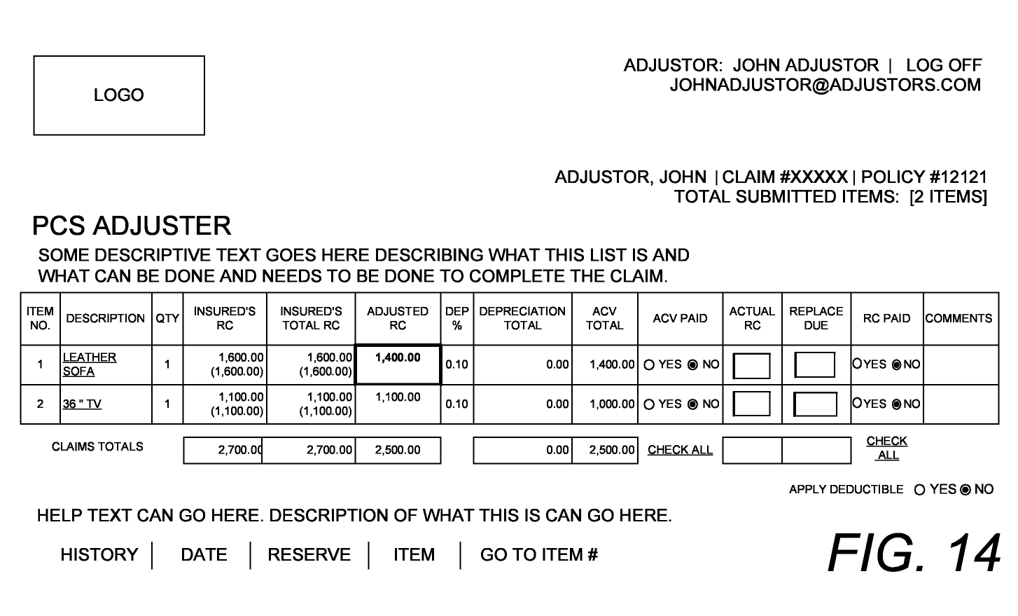

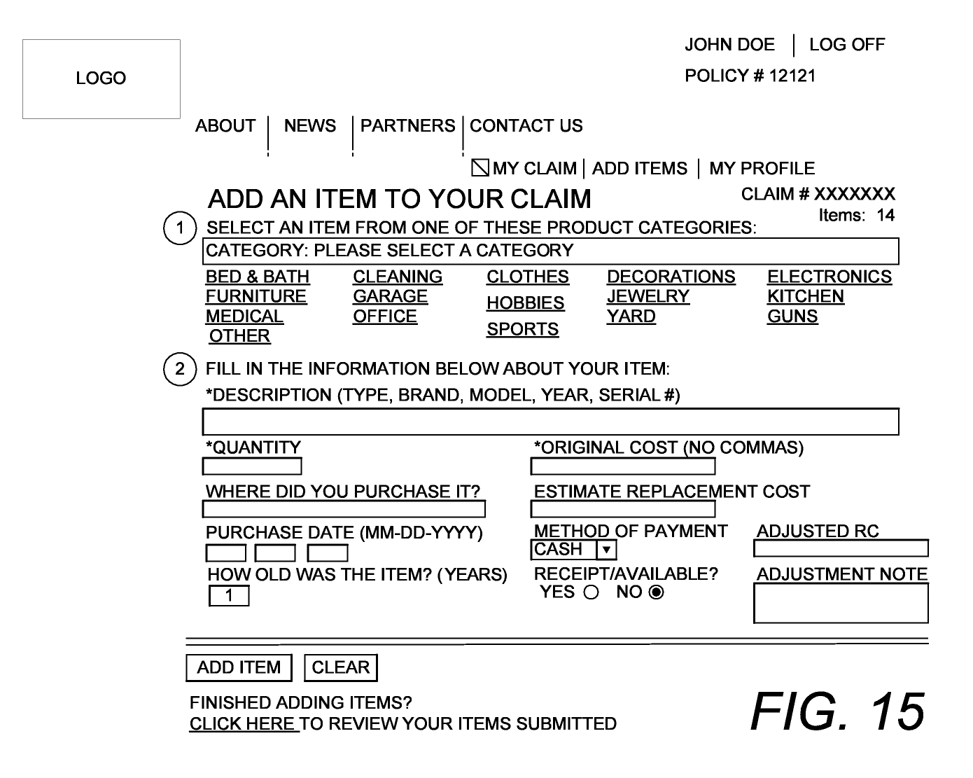

FIG. 13 shows the inventory loss procedure from the insurer 6 side of the web site 4 as previously shown and described in FIG. 4 including the additional steps of having item costs compared to item cost parameters at 108, and having an adjuster 10 provide an adjustment note, and flagging an item when the insured's 12 RC is changed by an adjuster 10 at 110. As described above, insured's 12 RCs are examined and unusually high values for individual items are flagged at 58. The maximum value for items that trigger the flag are determined by comparing items in the loss inventory to the item cost parameters at 108 which are pre-defined by the insurer 6. The flagging of high value items at 58 is determined by the item cost parameters at 108 allowing the insurer 6 to set parameters based on the insurer's 6 preferences for the cost of items, thereby warning the adjuster 10 of any item over a certain amount and that the item value should be verified. The adjuster 10 has the ability to verify and adjust the RC submitted by the insured 12, post a note associated with the item, and flag the item at 110. The adjuster's 10 adjustment note memorializes the reason the change was made, and the item is flagged by highlighting the adjusted RC value in the property loss claim (FIG. 14). The adjusted RC value, adjustment note, and highlighting are viewable on both the insured's 12 side of the website 4 and the insurer 6 side of the website 4 (FIG. 15). Based on the adjusted RC, payment can be provided to the insured 12 at 64 and the lost items replaced at 66 as described above.

FIG. 14 shows a screen on the insurer 6 side of the web site 4 which is used by the adjuster 10 to review the insured's 12 submitted items in connection with a property loss claim, and adjust or verify the insured's 12 submitted RC. Without limitation, the information displayed to the adjuster 10 related to each item of a claim includes, but is not limited to: item number; description; quantity; insured's RC; insured's total RC; adjusted RC; depreciation percentage; depreciation total; ACV total; actual RC; replace due; replacement paid; and comments. The CMS 2 allows the adjuster 10 to control the price paid for an item by adjusting the RC as described above at 110. The adjustment of a RC by an adjuster 10 causes an adjustment note to be posted as to the reason for the change. The CMS 2 flags the item by highlighting the adjusted RC value in the adjusted RC column. An example of flagging an item to be adjusted is represented in the adjusted RC value for item number one in FIG. 14. Both the adjusted RC and the adjustment note are viewable to both the insured 12 on the insured's side of the website 4, and to the adjuster 10 on the insurer's 6 side of the website 4. The adjuster's 10 adjustment note and the adjusted RC are viewable by selecting the item on the list and reviewing the information on the claim-related information screen (FIG. 15). The adjustment note permits the adjuster 10 to show the insurance carrier 8 that an item was verified and/or changed, potentially saving the insurer 6 money.

As described above, the claim is viewable by the insurance carrier 8, adjuster 10 and the insured 12 at various points in the claim submission process through the CMS 2. This enables the parties involved to track the payment to the insured 12 at 64 for claim items being replaced, and track the value of pending payments relative to prior payments made on the claim. The CMS 2 provides application delivery infrastructure enabling an insured 12 and adjuster 10 to work together when conducting the inventory procedure 46 of an insured's 12 claim on the website 4. If an insured 12 has difficulty using the CMS 2 after initiating the CMS 2 process and accessing the insured's 12 side of the website 4, they can engage an adjuster 10 assigned to the claim using remote access. Remote access enables an adjuster 10 to access an insured's 12 computer from a remote location and control movement of the pointing device (e.g. mouse) and keystroke input, as well as permit communication by two-way audio and/or video between the insured 12 and the adjuster 10. Such functionality permits an adjuster 10 to communicate with the insured 12 and to input claim information during the inventory procedure 46 as if they were the insured 12 by accessing the insured's 12 computer on the insured's 12 side of the website 4 and permitting the adjuster 10 to enter claim data therein as if they were the insured 12. Alternatively, the adjuster 10 may simply monitor the insured's 12 side of the website 4 while the insured 12 enters data and assisting the insured 12 only when needed.

The CMS 2 will appeal to many types of organizations that handle insurance claim processing transactions, including, but not limited to private insurance carriers 8, agency and independent adjusters 10, and the Federal Emergency Management Agency.

It is to be understood that the invention can be embodied in various forms, and is not to be limited to the examples discussed above. Other components and configurations can be utilized in the practice of the present invention.

Having thus described the invention, what is claimed as new and desired to be secured by Letters Patent is:

1. A method for interactively processing a property insurance claim, which comprises the steps of:
providing a claims management system including a website;
providing the website with an insured side and an insurer side;
providing a claim information submission subsystem on the insured side of the website;
providing a claim information management subsystem on the insurer side of the website;
providing an insured with a property loss claim with access to the insured side of the web site;
the insured creating a property loss claim on the insured side of the website;
the insured submitting information relating to lost or damaged items pertaining to the property loss claim;
receiving in the claims management system property-specific information relating to lost or damaged items associated with the property loss claim;
the insured submitting the property-specific information relating to lost or damaged items to the claims management system;
the insured submitting the property loss claim to the claims management system;
the insurer accessing the submitted property loss claim on the insurer side of the website;
providing predetermined claim item lost parameters;
comparing the property-specific information relating to lost or damaged items in the submitted claim to cost parameters; and
providing the adjuster on the insurer side of the website with an indication when a submitted claim item exceeds cost parameters.

2. The method of claim 1, which includes the additional step of the insured returning to the insured side of the website to inventory property-specific information relating to lost or damaged items associated with the property loss claim before submitting the property loss claim to the claims management system.

3. The method of claim 1, which includes the additional steps of:
the insured providing the adjuster remote access to the insured's side of the website while the insured is creating a property loss claim; and
the adjuster submitting the property specific information relating to insured's loss or damaged items to the claims management system on the insured's side of the website.

4. The method of claim 2, which includes the additional steps of:
the adjuster adjusting the submitted property loss claim by providing an adjusted replacement cost;
the adjuster providing an adjustment note in connection with the adjusted replacement cost; and
displaying the adjusted replacement cost and the adjustment note on the insured's side and insurer's side of the website.

5. The method of claim 3, which includes the additional steps of providing two-way audio and video communication between insured and adjuster.

6. A method for interactively processing an insurance claim, which comprises the steps of:
providing a web site with an insured side and an insurer side;
providing a claims management system with claim-related information including predetermined categories relating to insurance claims;
providing an insured with a loss with access to the claims management system from the insured side of the web site;
providing the insurer with a unique identification;
displaying said insurer's unique identification on the insured and insurer sides of the web site;
providing the insured with a password for accessing the insured's side of the web site;
receiving in the claims management system item-specific information relating to lost or damaged items associated with the claim;
providing an inventory of said lost or damaged items associated with said claim in said predetermined categories;
inventorying the items with the claims management system;
generating an inventory of items from said item-specific information;
tabulating, verifying and reviewing said inventory in connection with said transaction;
providing an insurance company with access to the claims management system from the insurer side of the web site;
displaying said predetermined categories on said insured side of said web site;
receiving the item-specific information in said predetermined categories displayed on the insured side of the web site;
adjusting the claim from the insurer side of the web site;
the insurer assigning the claim to an adjuster;
the adjuster obtaining from the insured and submitting to the insurer claim-related information;
adjusting said claim using criteria chosen from a list including: purchase date; item age;
original cost; actual cash value (ACV); replacement cost (RC); insurance policy reserves; and depreciation;
linking said claims management system to vendors for replacement cost information for said lost or damaged items;
providing a shopping cart type procedure for placing replacement items in a virtual shopping cart using such vendor-provided cost information;
indicating to said insured a full shopping cart type condition when the inventory procedure is complete;
said insured purchasing the shopping cart contents from said vendors;
said vendors compensating the claims management system administrator for being linked to said claims management system and for said referrals of insureds with property losses;
generating periodic reports pertaining to said claim to said insurer and said insured;
applying predetermined claim adjustment guidelines by the insurer to the submitted claim-related information;
submitting predetermined types of pre-replacement information pertaining to lost or damaged items prior to replacement of same via the insurer side of the web site;
submitting predetermined types of post-replacement information pertaining to lost or damaged items after replacement via the insurer side of the web site;
the claims management system listing the open or active claim files of an adjuster on the insurer side of the web site;
the adjuster accessing said open or active claim file list;
the adjuster archiving claim files on the claims management system;
providing the adjuster with an indication when a claim item exceeds predetermined claim adjustment guidelines;
the claims management system including guidelines for total yearly purchases of certain categories of property;
examining the insured's claim for total yearly purchases of lost or damaged items in such categories prior to said property loss occurrence;
comparing the insured's total yearly purchases of lost or damaged items in such categories with said guidelines;
flagging for further inquiry unusually high total purchase amounts or total purchase amounts which exceed such guidelines for further inquiry, verification and/or adjustment;
the adjuster making further inquiry, verification and/or adjustment with respect to said claim amounts exceeding said guidelines;
the adjuster manually overriding said guidelines;
the adjuster submitting to the claims management system information explaining such manual overrides based on his or her further inquiry cover vacation and/or adjustment with respect to said claim amounts exceeding said guidelines; and
updating a property and casualty industry database with information from said claim, said information including items damaged or lost by category and the replacement costs thereof.

7. The method of claim 6, which includes the additional step of the insured returning to the insured side of the website to provide item-specific information relating to lost or damaged items associated with the claim.

8. The method of claim 6, which includes the additional steps of:
the insured providing the adjuster remote access to the insured's side of the website while the insured is creating a property loss claim; and
the adjuster submitting the item-specific information relating to insured's loss or damaged items to the claims management system on the insured's side of the website.

9. The method of claim 7, which includes the additional steps of:
the adjuster adjusting the submitted property loss claim by providing an adjusted replacement cost;
the adjuster providing an adjustment note in connection with the adjusted replacement cost; and
displaying the adjusted replacement cost and the adjustment note on the insured's side and insurer's side of the website.

10. The method of claim 8, which includes the additional steps of providing two-way audio and video communication between insured and adjuster.

11. A method for interactively processing an insurance claim, which comprises the steps of:
providing a web site with an insured side and an insurer side;
providing a claims management system with claim-related information including predetermined categories relating to insurance claims;
providing an insured with a loss with access to the claims management system from the insured side of the web site;
providing the insurer with a unique identification;
displaying said insurer's unique identification on the insured and insurer sides of the web site;
providing the insured with a password for accessing the insured's side of the web site;
receiving in the claims management system item-specific information relating to lost or damaged items associated with the claim;
providing an inventory of said lost or damaged items associated with said claim in said predetermined categories;
inventorying the items with the claims management system;
generating an inventory of items from said item-specific information;
tabulating, verifying and reviewing said inventory in connection with said transaction;
providing an insurance company with access to the claims management system from the insurer side of the web site;
displaying said predetermined categories on said insured side of said web site;
receiving the item-specific information in said predetermined categories displayed on the insured side of the web site;
adjusting the claim from the insurer side of the web site;
the insurer assigning the claim to an adjuster;
the adjuster obtaining from the insured and submitting to the insurer claim-related information;
adjusting said claim using criteria chosen from a list including: purchase date; item age;
original cost; actual cash value (ACV); replacement cost (RC); insurance policy reserves; and depreciation;
linking said claims management system to vendors for replacement cost information for said lost or damaged items;
providing a shopping cart type procedure for placing replacement items in a virtual shopping cart using such vendor-provided cost information;
indicating to said insured a full shopping cart type condition when the inventory procedure is complete;
said insured purchasing the shopping cart contents from said vendors;
said vendors compensating the claims management system administrator for being linked to said claims management system and for said referrals of insureds with property losses;
generating periodic reports pertaining to said claim to said insurer and said insured;
applying predetermined claim adjustment guidelines by the insurer to the submitted claim-related information;
submitting predetermined types of pre-replacement information pertaining to lost or damaged items prior to replacement of same via the insurer side of the web site;
submitting predetermined types of post-replacement information pertaining to lost or damaged items after replacement via the insurer side of the web site;
the claims management system listing the open or active claim files of an adjuster on the insurer side of the web site;
the adjuster accessing said open or active claim file list;
the adjuster archiving claim files on the claims management system;
providing the adjuster with an indication when a claim item exceeds predetermined claim adjustment guidelines;
the claims management system including guidelines for total yearly purchases of certain categories of property;
examining the insured's claim for total yearly purchases of lost or damaged items in such categories prior to said property loss occurrence;
comparing the insured's total yearly purchases of lost or damaged items in such categories with said guidelines;
flagging for further inquiry unusually high total purchase amounts or total purchase amounts which exceed such guidelines for further inquiry, verification and/or adjustment;
the adjuster making further inquiry, verification and/or adjustment with respect to said claim amounts exceeding said guidelines;
the adjuster manually overriding said guidelines;
the adjuster submitting to the claims management system information explaining such manual overrides based on his or her further inquiry cover vacation and/or adjustment with respect to said claim amounts exceeding said guidelines;
updating a property and casualty industry database with information from said claim, said information including items damaged or lost by category and the replacement costs thereof,
the insured returning to the insured side of the website to provide item-specific information relating to lost or damaged items associated with the claim;
the insured providing the adjuster remote access to the insured's side of the website while the insured is creating a property loss claim;
the adjuster submitting item-specific information relating to insured's loss or damaged items to the claims management system on the insured's side of the website;
the adjuster adjusting the submitted property loss claim by providing an adjusted replacement cost;
the adjuster providing an adjustment note in connection with the adjusted replacement cost;
displaying the adjusted replacement cost and the adjustment note on the insured's side and insurer's side of the website; and
providing two-way audio and video communication between insured and adjuster.
